(19) United States
(12) Patent Application Publication
(10) Pub. No.: US 2007/0146268 A1
(43) Pub. Date: Jun. 28, 2007

(54) Method of realizing images in a portable display apparatus

(75) Inventors: Young-Min Jeong, Suwon-si (KR); Sung-Dae Cho, Yongin-si (KR); Seok-Jin Won, Seongnam-si (KR); Chang-Sup Shim, Seoul (KR); Chang-Hwan Son, Buk-gu (KR); Young-Ho Ha, Buk-gu (KR); Cheol-Hee Lee, Buk-gu (KR); Jong-Man Kim, Buk-gu (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/584,685

(22) Filed: Oct. 20, 2006

(30) Foreign Application Priority Data
Dec. 26, 2005 (KR) 2005-129830

(51) Int. Cl. G09G 3/36

(52) U.S. Cl. 345/88

(57) ABSTRACT

A method of realizing images in a portable display apparatus including a camera module and an LCD monitor includes the steps of: converting three primary lights, which are realized by the camera module, into a first tri-stimulus value; converting the first tri-stimulus value into a second tri-stimulus value through a color gamut mapping of the first tri-stimulus value for the LCD monitor; and converting the second tri-stimulus value into three primary lights for images the LCD monitor is configured to display and then transferring the three converted-to primary lights to the LCD monitor.

### CLAIM OF PRIORITY

This application claims priority to an application entitled “Method of Realizing Images in a Portable Display Apparatus,” filed with the Korean Intellectual Property Office on Dec. 26, 2005 and assigned Serial No. 2005-129830, the contents of which are incorporated herein by reference.

### BACKGROUND OF THE INVENTION

1. Field of the Invention

The present invention relates to a method of improving the color reproduction of a display apparatus, and more particularly to a method of realizing color-compensated images in a display apparatus including a camera module and a LCD monitor.

2. Description of the Related Art

Colors may be abnormally viewed when the observer is in certain environments. It is also difficult to maintain the objectivity of colors during the transmission of the colors. Therefore, a color standard is necessary for accurately measuring and realizing colors. Reference to a color standard has accordingly often been required. The Commission International De L'Eclairage (CIE) is an international organization concerned with solving the above-mentioned problem. The CIE has proposed a CIE tri-stimulus value based on an RGB (red-green-blue) function which is a function of three primary lights or colors.

The RGB function, which yields respective component amounts of red, green and blue light to be mixed in achieving a desired color, may form at least one negative value for a component. The negative value has no physical meaning in terms of color mixing. Therefore, where a display apparatus is realized by using the RGB function, an algorithm may be complicated and may accumulate increasing error due to the occurrence of the negative value. A transformation into tri-stimulus values based on XYZ can change negative into positive values, thereby solving the problem.

In the case of an LCD monitor used for a portable display apparatus and having, in comparison with a CRT, deteriorated luminance and chromaticity, noise and distortion are generated in the colors during the quantization and the digital post-treatment of the colors.

To relieve noise and distortion, conventional display apparatuses have employed a compensation method utilizing a three dimensional reference table or, alternatively, a Gene Ontology Grid (GOG) modeling method or S-curve modeling method utilizing merely a small amount of measured data.

The compensation method using the three-dimensional reference table assumes an input/output relation of light and electricity for which the stimulus value of the display apparatus depends upon a three-dimensional interpolation method for a measured tri-stimulus value or CIELAB value.

Advantageously, for this method, reliability of data is excellent, although it is necessary to measure a large amount of data and perform repeated tests utilizing measuring instruments.

The GOG modeling method and the S-curve modeling method, on the other hand, can obtain reliable data by using a relatively small amount of measured data. Specifically, the GOG modeling method is well applicable to numerical index characteristics of an input/output curve of electricity-light in the CRT, while the S-curve modeling method is applicable to the modeling of an input/output curve of S-lined electricity-light in the LCD.

However, the existing GOG or S-curve modeling methods are applicable to common CRTs and LCDs, e.g., desktop devices; whereas they cannot easily be applied to LCD monitors used in portable display apparatuses which have an image characteristic realized with few bits, e.g., at low bit depth, and an operation characteristic in a low electricity state. Accordingly, most suitable gamut mapping methods as described above have not, to-date, been realized in the LCD monitor of a portable terminal apparatus. Colors, as the user would recognize them directly with his/her eyes may, as a consequence, vary considerably from how the colors appear on the LCD monitor.

### SUMMARY OF THE INVENTION

The present invention has been made to solve the above-mentioned problems occurring in the prior art, and, in one aspect, provides a method of compensating images, and for realizing images for which the colors are compensated to nearly match image information obtained from a camera module, thereby improving color reproduction in a portable display apparatus.

In order to accomplish the above aspect, there is provided a method of realizing images in a portable display apparatus including a camera module and an LCD monitor, which comprises the steps of: converting three primary lights, which are realized by the camera module, into a first tri-stimulus value; converting the first tri-stimulus value into a second tri-stimulus value through a color gamut mapping of the first tri-stimulus value for the LCD monitor; and converting the second tri-stimulus value into three primary lights for images the LCD monitor is configured to display, and then transferring the converted-to three primary lights to the LCD monitor.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating an independent color matching process in a portable display apparatus, according to the preferred embodiment of the present invention;

FIG. 2 is a graph illustrating an input/output characteristic of electricity and light of a portable display apparatus using a GOG modeling method;

FIG. 3 is a graph illustrating an input/output characteristic of electricity and light of a portable display apparatus using an S-curve modeling method;

FIG. 4 is a view illustrating an input/output characteristic of electricity and light of a portable display apparatus using a sigmoidal modeling method;

FIG. 5 is a graph showing a color gamut of a camera module and a color gamut of an LCD monitor, shown in FIG. 1;

FIG. 6 is a flowchart showing an algorithm for generating a look-up table between the camera module and the LCD monitor; and

FIGS. 7A and 7B are photographs used for comparing color matching of the conventional portable display apparatus with that of the portable display apparatus according to the present invention.

### DETAILED DESCRIPTION

In the discussion to follow, detailed description of known functions and configurations incorporated herein is omitted for conciseness and clarity of presentation.

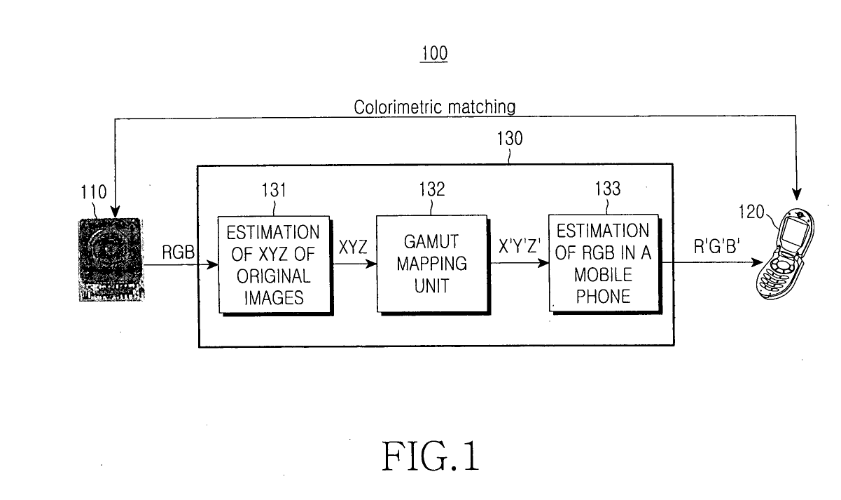

FIG. 1 depicts, by way of illustrative and non-limitative example, an independent color matching process in a portable display apparatus, according to the preferred embodiment of the present invention. Referring to FIG. 1, a method of realizing images in a portable display apparatus 100, which includes a camera module 110 and an LCD monitor 120, entails a step 131 of converting three primary lights (RGB) into a first tri-stimulus value (XYZ) for images captured by a camera module 110. The portable display apparatus 100 may be, for example, a mobile phone, personal digital assistant (PDA), laptop terminal, Motion Pictures Expert Group 1 (MPEG-1) layer 3 (MP3) player, etc. The three primary lights can be additive primary colors, e.g., RGB, for a camera, as in the present example. The next step 132 converts the first tri-stimulus value into a second tri-stimulus value (X′Y′Z′) through color gamut mapping of the first tri-stimulus value for the LCD monitor 120. Then, a step 133 converts the second tri-stimulus value into three primary lights (R′G′B′) for images realized by the LCD monitor 120 and transfers the three primary lights (R′G′B′) to the LCD monitor 120. Here, again, the transferred three primary lights may be additive primary colors for an LCD. Although the monitor in the present embodiment is implemented as an LCD, the intended scope of the invention is not so limited.

The RGB images taken by the camera module 110 are compared with data obtained during the characterization of the camera module, and then are converted into the first tri-stimulus value (CIE XYZ). Step 132 converts, by means of the color gamut mapping, and for realization on the LCD monitor 120, the first tri-stimulus value into the second tri-stimulus value (X′Y′Z′). The mapping algorithm is preferably a variable multi-point gamut mapping algorithm.

The second tri-stimulus value is, in turn, converted into the three primary lights (R′G′B′) for images realized by the LCD monitor 120, and then the three primary lights (R′G′B′) are provided as image information through the LCD monitor to the user.

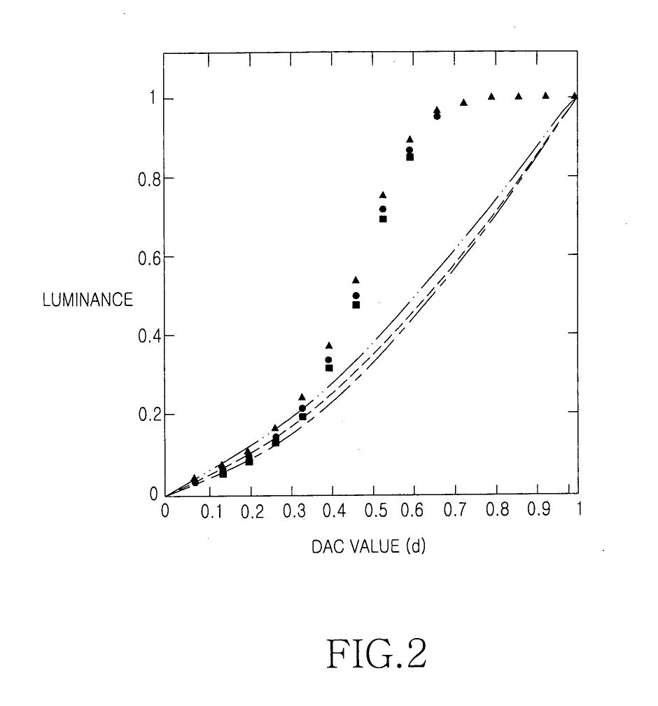

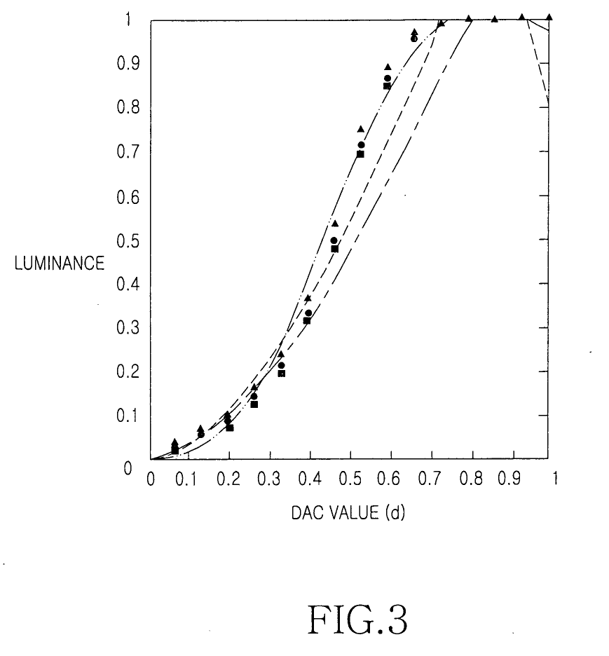

FIGS. 2 and 3 are graphs illustrating one example of an input/output characteristic of electricity and light of a portable display apparatus using, respectively, a GOG modeling method and an S-curve modeling method. Digital driving levels based correspondingly on pixel-dependent digital values are inputted by a digital-to-analog converter (DAC) to yield luminance levels. The X-axis is normalizes by dividing the R, G or B value, in the range 0˜255, by 255. The Y axis indicates the luminance values derived from driving levels. Squares ▪, circles , and triangles ▴ represent R, B and B values, respectively. Broken lines in the long-short pattern are relation curves between the R value and the L value (L of CIELAB) according to the sigmoidal modeling used in an embodiment of the present invention. The uniformly broken line is a relation curve between the G value and the L value (L of CIELAB) according to the sigmoidal modeling. The double-dotted broken line is a relation curve between the B value and the L value (L of CIELAB) according to the sigmoidal modeling.

It will be noted that luminance of the LCD monitor 120 has no gamma or S type characteristics even though digital values increase differently from those of the general monitors.

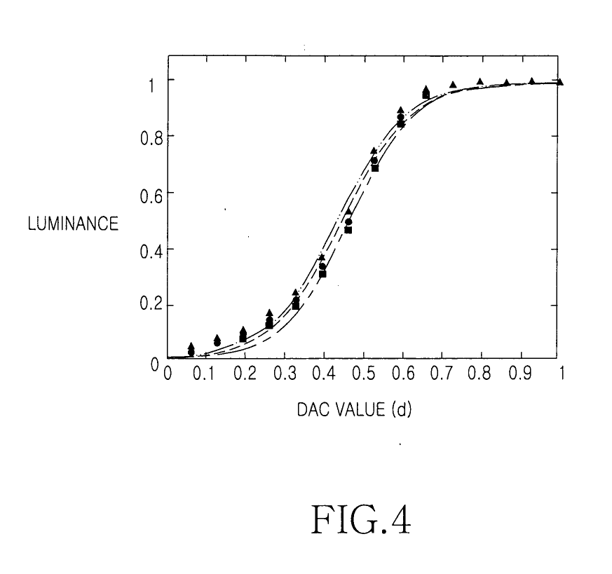

This stands in contrast to FIG. 4 which illustrates characterizing the display apparatus using a sigmoidal function similar to an input/output characteristic of electricity and light of the LCD monitor 120 used in the portable display apparatus 100 of the present invention. In the graph of FIG. 4, a standard color chart such as Gretag Color Checker is taken under a D65 light source by a camera module to be characterized, and then an RGB value of taken images and the tri-stimulus value (CIEXYZ or CIELAB) provided by the standard color chart can be calculated by multiple regression.

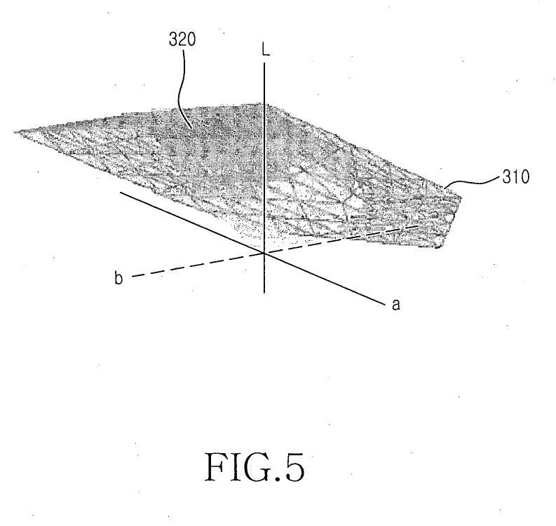

FIG. 5 shows exemplary color gamuts 310, 320 of the camera module 110 and the LCD monitor 120, respectively, under D65 circumstance. In particular, D65 is a specific, reference illuminant. An illuminant specifies a light source by relative energy per wavelength or wavelength band. A variable multiple anchor point gamut mapping algorithm is applied to the color gamuts 310, 320, which have a net structure. Specifically, the gamut mapping algorithm in FIG. 5 is an algorithm for realizing an independent color mapping in the display apparatus. A look-up table may be used in order to set the first tri-stimulus value which is within the color gamut 310 of the camera module 110 used as an input device to be identical with the second tri-stimulus value which is within the color gamut 320 of the LCD monitor 120 used as an output device.

The method of realizing images in the portable display apparatus 100 according to the present invention includes complicated steps requiring much data calculation, such as polynomial regression, gamut mapping, and interpolation, and also includes three non-linear calculation steps. Accordingly, a lookup table can be used to advantage.

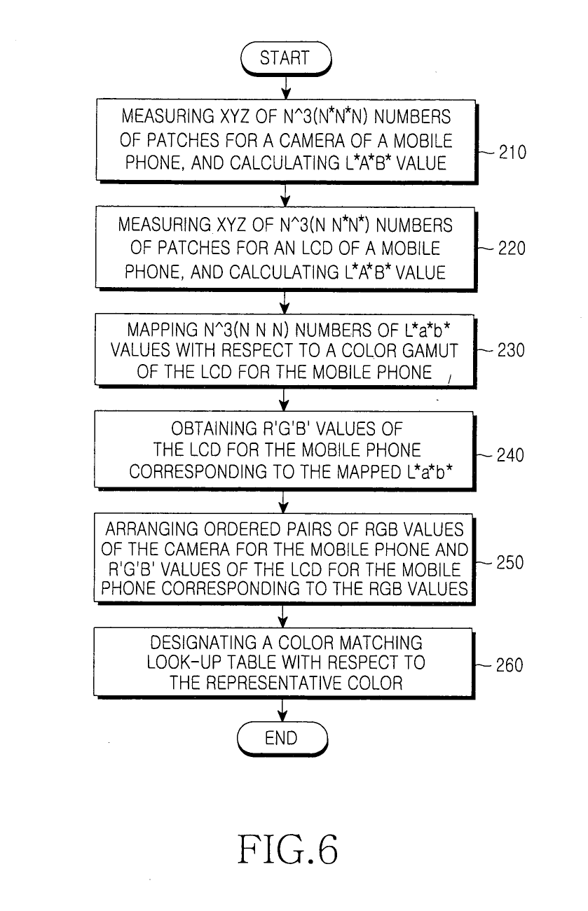

FIG. 6 is a possible algorithm for generating a look-up table between the camera module 110 and the LCD monitor 120 and illustrates the steps of realizing the present invention by replacing the steps shown in FIG. 1 with the look-up table. The size of the look-up table may be set according to the user's needs. The algorithm begins by, in step 210, measuring the XYZ value of the camera 110. Step 220 measures the XYZ value of the LCD 120. Step 230 calculates the L*a*b* value obtained by mapping the color gamut of the camera 110 and the LCD 120. Step 240 calculates the R′G′B′value of the LCD 120 corresponding to the mapped L*a*b* value. Step 250 arranges ordered pairs of RGB and R′G′B′ values. Step 260 designs the look-up table.

In FIG. 6, the letter N is the number of discrete, measured values for each of R, G, and B. In particular, R, G and B values are often each designated on a scale from zero (0) to two hundred fifty five (255). This implies 256×256×256 different possible color values, but color measurements by primary are quantized to only N values per primary in the instant embodiment, for a total of N³ colors in the resulting gamut.

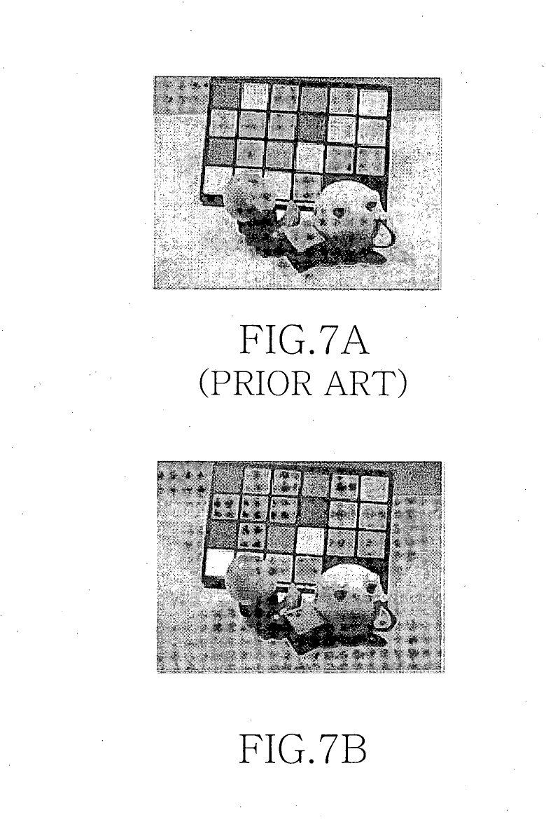

FIG. 7A shows a photograph of a conventional image, and FIG. 7B is a photograph of an image realized by the display apparatus which undergoes the color matching, according to the present invention. Specifically, in the photograph of FIG. 7A, it is noted that the bright region in the image is saturated due to the input/output characteristics of the light and the electricity. The bright region hardly reflects the colors in a Macbeth chart itself, because the image is taken by the camera module and then is directly transferred to the LCD monitor.

The photograph in FIG. 7B, by contrast, faithfully exhibits the saturation which human beings actually sense under D65 lighting.

In the portable display apparatus including the camera module, the present invention makes it possible to correct the color gamut of the camera module and the color gamut of the display device providing the images to the user. The user can recognize the colors to be substantially similar to the colors of an object, just as they were when the camera module took the picture of the object. That is, the user is presented the realistic images.

While the invention has been shown and described with reference to certain preferred embodiments thereof, it will be understood by those skilled in the art that various changes in form and details may be made therein without departing from the spirit and scope of the invention as defined by the appended claims. A device for performing the method, for example, is within the intended scope of the invention, and may include storage memory and a processor for executing the method steps, that processor being realized in hardware, software, firmware, or in any combination thereof.

What is claimed is:

1. A method of realizing images in a portable display apparatus including a camera module and an LCD monitor, comprising:
converting three primary lights, which are realized by the camera module, into a first tri-stimulus value;
converting the first tri-stimulus value into a second tri-stimulus value through a color gamut mapping of the first tri-stimulus value for the LCD monitor; and
converting the second tri-stimulus value into three primary lights for images the LCD monitor is configured to display and then transferring, to the LCD monitor, said three primary lights for images.

2. The method of realizing images in a portable display apparatus as claimed in claim 1, wherein said converting the first tri-stimulus value comprises using a sigmoidal model.

3. The method of claim 1, wherein the three primary lights to be converted into the first tri-stimulus value are three additive primary colors for the camera module.

4. The method of claim 3, wherein said three primary lights for images are three additive primary colors for the LCD monitor.

5. The method of claim 1, wherein said three primary lights for images are three additive primary colors for the LCD monitor.

6. A method of realizing images in a portable display apparatus including a camera module and a monitor, comprising:
converting three primary lights measured by the camera module as input, into a first tri-stimulus value;
converting the converted-to first tri-stimulus value into a second tri-stimulus value through a color gamut mapping of the first tri-stimulus value for the monitor; and
converting the converted-second tri-stimulus value into three primary lights for images the LCD monitor is configured to display and then transferring, to the monitor, said three primary lights for images.

7. The method of realizing images in a portable display apparatus as claimed in claim 6, wherein said converting the converted-to first tri-stimulus value comprises using a sigmoidal model.

8. The method of claim 6, wherein the three primary lights to be converted into the first tri-stimulus value are three additive primary colors for the camera module.

9. The method of claim 8, wherein said three primary lights for images are three additive primary colors for the monitor.

10. The method of claim 9, wherein the monitor is an LCD monitor.

11. The method of claim 6, wherein said three primary lights for images are three additive primary colors for the monitor.

12. The method of claim 6, wherein said monitor is an LCD monitor.

13. The portable display apparatus of claim 6, configured with memory and a processor for executing said method.

14. The portable display apparatus of claim 13, implemented as a mobile phone.

15. The portable display apparatus of claim 14, configured such that said converting the converted-to first tri-stimulus value comprises using a sigmoidal model.

16. The portable display apparatus of claim 13, configured such that said converting the converted-to first tri-stimulus value comprises using a sigmoidal model.

17. The portable display apparatus of claim 12, configured such that said converting the converted-to first tri-stimulus value comprises using a sigmoidal model.

18. The portable display apparatus of claim 1, configured with memory and a processor for executing said method.
